(19) United States
(12) Patent Application Publication
(10) Pub. No.: US 2025/0206111 A1
(43) Pub. Date: Jun. 26, 2025

(54) CONVERTIBLE TOP HAVING A ROOF SKIN ARRANGEMENT AND CONVERTIBLE TOP LINKAGE

(71) Applicant: Webasto SE, Stockdorf (DE)

(72) Inventors: Armin ANZINGER, Stockdorf (DE); Alexander HAIMERL, Stockdorf (DE)

(21) Appl. No.: 18/971,462

(22) Filed: Dec. 6, 2024

(30) Foreign Application Priority Data
Dec. 22, 2023 (DE) 10 2023 136 590.8
Feb. 6, 2024 (DE) 10 2024 103 221.9

(51) Int. Cl. B60J 7/14

(52) U.S. Cl. CPC B60J 7/143

(57) ABSTRACT

A convertible top comprising a roof skin arrangement and a convertible top linkage by which the roof skin arrangement is displaceable between a cover position spanning the vehicle interior and a storage position releasing the vehicle interior towards the top and which has a link arrangement on either side of a vertical longitudinal convertible-top center plane, the link arrangements each being mounted so as to be pivotable on a respective main bearing, which is displaceable on a guide rail by a drive arrangement, the drive arrangement having a lever arrangement which is hinged to the main bearings and which is driven by at least one drive motor.

### CROSS-REFERENCE TO RELATED APPLICATION(S)

This application claims the benefit of German patent application No. 10 2023 136 590.8, filed on Dec. 22, 2023, and German patent application No. 10 2024 103 221.9, filed on Feb. 6, 2024, which are both incorporated herein by reference in their entirety.

### TECHNICAL FIELD

A convertible top having a roof skin arrangement and a convertible top linkage by means of which the roof shell arrangement is displaceable between a cover position spanning a vehicle interior and a storage position releasing the vehicle interior towards the top.

### BACKGROUND

A convertible top which is formed as a so-called RHT (Retractable Hard Top) or as a convertible roof and which is part of a convertible vehicle is known from patent document DE 102 94 214 B4, for example. The convertible top forms a displaceable vehicle roof, which comprises rigid roof shells as a roof skin arrangement and a convertible top linkage. By means of the convertible top linkage, the rigid roof shells, which form a convertible top cover, can be displaced between a cover position spanning the vehicle interior, in which the roof shells are disposed behind each other in the longitudinal roof direction, and a storage position releasing the vehicle interior towards the top, the roof shells being housed in a convertible top storage area, which is disposed to the rear of a vehicle interior. The convertible top linkage comprises a link arrangement on either side of a vertical longitudinal convertible-top center plane, said link arrangement having a main link arrangement, which comprises two main links which form a multi-bar linkage and which are disposed on a main bearing fixed to the body of the vehicle. A drive unit for the main link arrangement is disposed in the area of the main bearing. In the storage position, the roof shells are disposed essentially horizontally one above the other in the convertible top storage area. For this purpose, the storage area must be designed in such a way that it offers sufficient space in the longitudinal vehicle direction.

### SUMMARY

The object of the invention is to provide a convertible top configured according to the kind mentioned above in which the roof skin arrangement can adopt a position optimized for a given vehicle type when in the storage position.

According to the invention, this object is attained by the convertible top having the features of patent claim 1.

The invention proposes a convertible top comprising a roof skin arrangement and a convertible top linkage by means of which the roof skin arrangement is displaceable between a cover position spanning a vehicle interior and a storage position releasing the vehicle interior towards the top and which comprises a link arrangement on either side of a vertical longitudinal convertible-top center plane, said link arrangements each being mounted so as to be pivotable on a respective main bearing, which is displaceable on a guide rail by means of a drive arrangement. The drive arrangement comprises a lever arrangement which is hinged to the main bearings and which is driven by at least one drive motor.

With the convertible top according to the invention, the main bearings, on which the link arrangements are mounted so as to be pivotable, can be displaced, in particular between a lifted position and a lowered position. In the lifted position, the cover position of the convertible top can be realized, in which the roof skin arrangement spans or covers the vehicle interior. In the storage position of the convertible top, the main bearings adopt in particular a lowered position, which allows a low placement of the roof shells in the convertible top storage area relative to the structure of the respective vehicle.

In particular, the main bearings, on which the link arrangements are mounted, can be configured as sliders, which can be displaced on the guide rails.

The roof skin arrangement of the convertible top according to the invention is preferably a roof shell arrangement, meaning that the convertible top is a convertible roof or an RHT (Retractable Hard Top). The roof shell arrangement comprises in particular two rigid roof shells, which are each disposed on either side on a respective link arrangement and, in the cover position, are disposed behind each other in the longitudinal vehicle direction in such a manner that their outer sides merge essentially flush with one another. With respect to the vehicle alignment, a front roof shell is fixed on a front header of the respective vehicle structure in the cover position. In the storage position, the two roof shells can be upright or vertical and be mounted so as to be arched in the same way, meaning with a rectified curvature, one behind the other in the convertible top storage area. Relative to the cover position, the roof shells are then pivoted, in particular by 70° to 110°. The edges of the roof shells, which point towards the front of the vehicle in the cover position, point towards the top in the storage position.

In an alternative embodiment of the convertible top according to the invention, the roof skin arrangement comprises a foldable convertible top cover, which is deployable by means of the convertible top linkage for establishing the cover position.

Each link arrangement of the convertible top linkage can form two multi-bar linkages which are coupled to each other. For example, a first multi-bar linkage is formed by a four-bar linkage, which is disposed on the main bearing and on which the rear roof shell is mounted in the case of a multi-shell roof shell arrangement. The second multi-bar linkage can form a seven-bar linkage which has a bearing link on which the front roof shell is mounted.

In a preferred embodiment of the convertible top according to the invention, the lever arrangement of the drive arrangement for the main bearing comprises a plurality of links which are pivotable in the transverse convertible-top direction. This means that only a small amount of installation space is required in the longitudinal vehicle direction or the longitudinal convertible-top direction in the vehicle structure. So the drive kinematic system which is formed by the drive arrangement and which is located in particular in front of the roof shell arrangement, whose roof shells are disposed upright, when in the storage position can be disposed in a manner favorable in terms of the package.

In another specific embodiment of the convertible top according to the invention, the lever arrangement comprises two main links or displacement links which are each hinged to one of the main bearings and whose respective end facing away from the respective main bearing is guided on a guide track extending in the transverse convertible-top direction. The guiding in the guide tracks is preferably effected by a slider to which the relevant main link is linked. The guide track is essentially horizontal in the transverse vehicle direction.

In the lifted position of the main bearing, the main links are preferably positioned essentially parallel to the guide rails for the main bearing in a projection in the longitudinal direction of the convertible top. If the sliders of the main links are displaced on the guide tracks in the transverse convertible-top direction, the main bearings are lowered or lifted. Thus, the main bearings are displaced in the vertical vehicle direction. In the lifted position, in which the main link is preferably positioned parallel to the guide rails and which constitutes an end position of the main bearing, a quasi-locking of the main bearing can be achieved by appropriate stops for the sliders of the main link. It is also conceivable that the main link then takes up an over-dead-center position and the sliders guided in the guide tracks rest on the stops in this position, whereby the quasi-locking of the main bearing is realized.

Each of the two main links of the drive arrangement of the convertible top according to the invention is preferably connected to a drive link arrangement which is driven by the drive motor. The drive link arrangement can be configured as an intermediate transmission or gear reducer and have at least two links, for example. The link of the drive link arrangement furthest away from the drive motor is hinged to the respective main link.

In another specific embodiment of the convertible top according to the invention, in which the drive arrangement for the main bearing has a particularly precisely guided lever arrangement, each main link is connected to a support link, whose respective end facing away from the main link is supported on a vehicle-mounted bearing. For the sake of completeness, it should be noted that the drive link arrangements, by means of which the main links are driven, can also be hinged to the support link. Thus, each support link forms a part of the respective drive link arrangement.

The drive arrangement of the convertible top according to the invention is preferably configured such that the two main bearings are driven synchronously when they are displaced on the guide rails. This is realized, for example, by the fact that the two main links are each driven by a separate drive motor, which is designed as an electric motor, and that the two drive motors are electronically synchronized. However, it is also conceivable that drive gears driven by the two drive motors and connected to the drive link arrangement are in mesh with each other. Furthermore, it is conceivable that the two main links are driven by a shared drive motor.

The at least one drive motor can be mounted on a transverse connector or a connecting element, for example, between the two guide tracks extending in the transverse convertible-top direction. This connecting element thus forms a bearing for the at least one drive motor of the drive arrangement.

Further advantages and advantageous embodiments of the subject matter of the invention can be derived from the description, the drawing and the patent claims. The invention relates to all combinations comprising at least two features disclosed in the description, the claims and/or the figures; i.e., each feature mentioned in the description can in itself be part of the claimed subject matter independently of the further features and/or specifications mentioned in the respective context.

### BRIEF DESCRIPTION OF DRAWINGS

An embodiment of a convertible top according to the invention is illustrated schematically simplified in the drawing and is described in more detail hereinafter.

FIG. 1 shows a schematic partial side view of a convertible vehicle having a convertible top according to the invention in its cover position;

FIG. 2 shows a view of the convertible top corresponding to FIG. 1, but in an intermediate positon during the displacement to a storage position;

FIG. 3 also shows a view of the convertible top corresponding to FIG. 1, but in another intermediate positon during the displacement to the storage position;

FIG. 4 shows a view of the convertible top corresponding to FIG. 1, but in another intermediate positon during the displacement to the storage position;

FIG. 5 shows a side view of the convertible top in a storage position;

FIG. 6 sows an inner view of the convertible top in its cover position;

FIG. 7 shows an inner view of the convertible top corresponding to FIG. 6, but in an intermediate positon during the displacement to the storage position;

FIG. 8 shows an inner view of the convertible top of the storage position, but in an unsecured state;

FIG. 9 shows an inner view of the convertible top corresponding to FIG. 8, but in a secured state;

FIGS. 10a and b show side views of a convertible top linkage of the convertible top in the cover position from the outside and from the inside;

FIGS. 11a and b show side views of the convertible top linkage corresponding to FIGS. 10a and b, but in a first intermediate positon during the displacement to the storage position;

FIGS. 12a and b show side views of the convertible top linkage corresponding to FIGS. 10a and b, but in a second intermediate positon during the displacement to the storage position;

FIGS. 13a and b show side views of the convertible top linkage corresponding to FIGS. 10a and b before being lowered to the storage position;

FIG. 14 shows a perspective rear view of the convertible top linkage in the cover position;

FIG. 15 shows a top view of the convertible top linkage in the cover position;

FIG. 16 shows a partly transparent view of the convertible top linkage in its cover position;

FIG. 17 shows a view of the convertible top linkage corresponding to FIG. 16, but in a first intermediate positon during the displacement to the storage position;

FIG. 18 shows a view of the convertible top linkage corresponding to FIG. 16, but in an unsecured storage position;

FIG. 19 also shows a view of the convertible top linkage corresponding to FIG. 16, but in the secured storage position;

FIG. 20 shows a rear view of a lifting mechanism of the convertible top linkage in the cover position;

FIG. 21 shows a view of the lifting mechanism corresponding to FIG. 20 in a first intermediate positon when lowering the convertible top;

FIG. 22 shows a view of the lifting mechanism corresponding to FIG. 20, but in a second intermediate positon when lowering the convertible top; and

FIG. 23 also shows a view of the lifting mechanism corresponding to FIG. 20, but in the lowered storage position of the convertible top.

### DETAILED DESCRIPTION

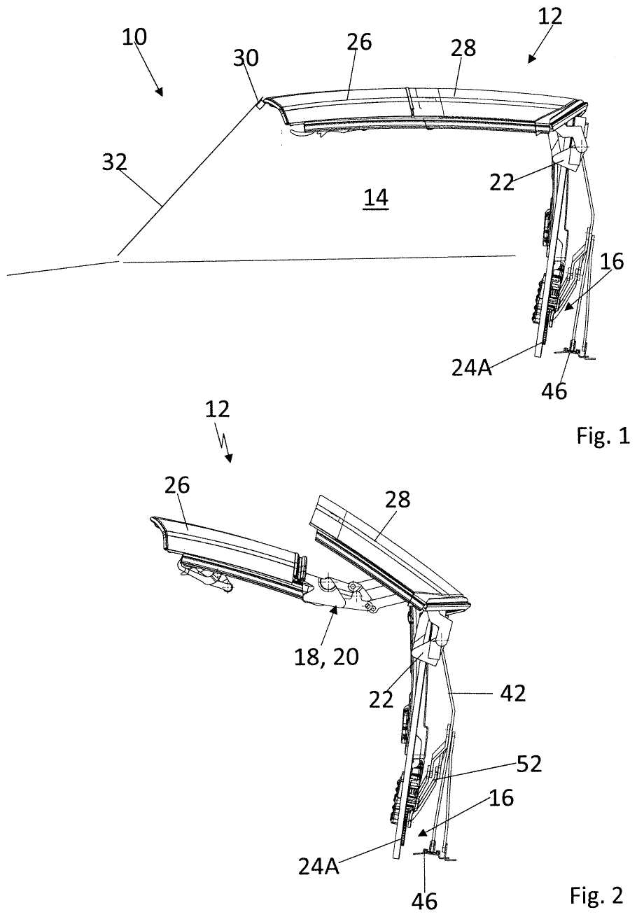

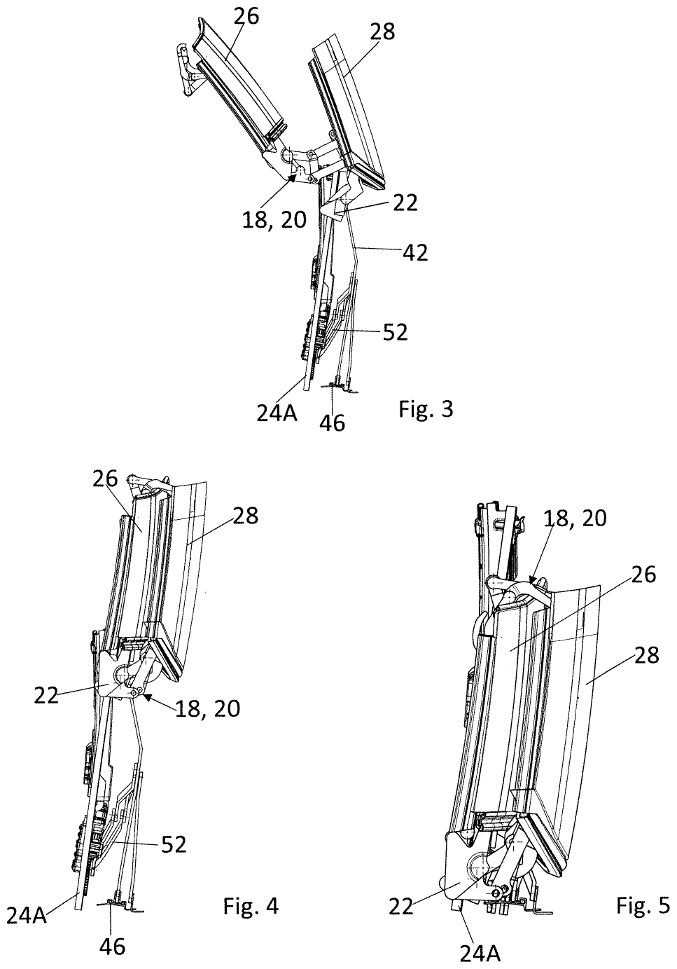

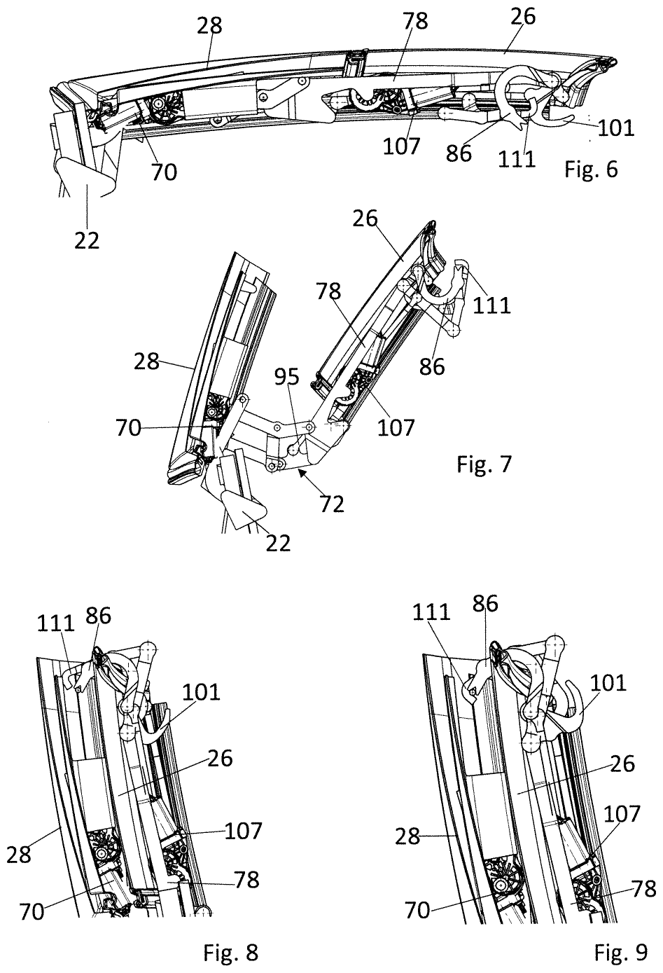

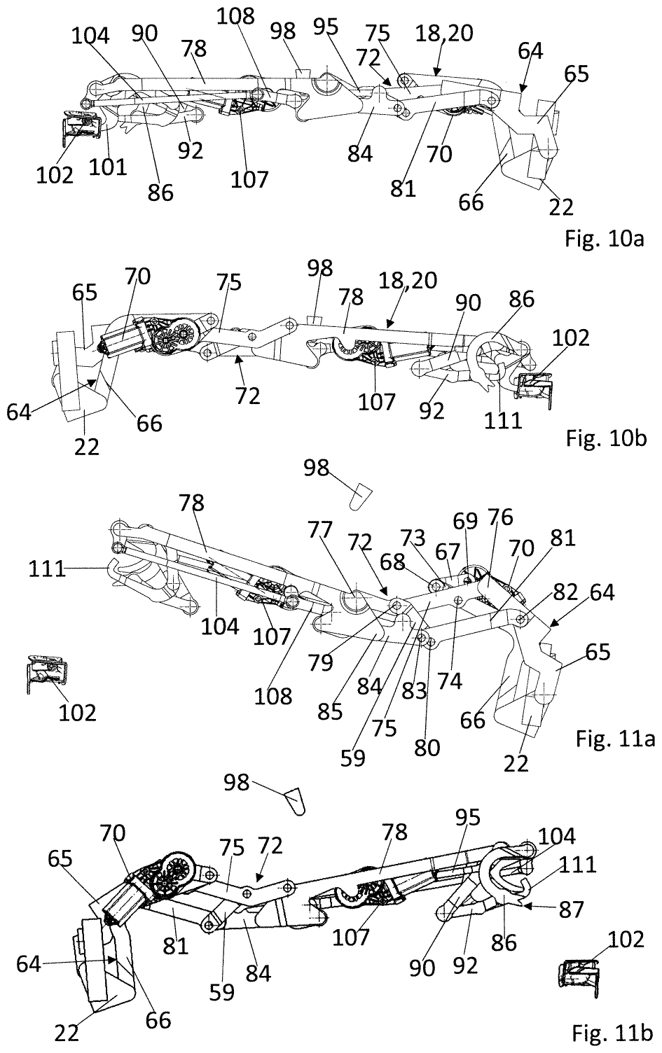

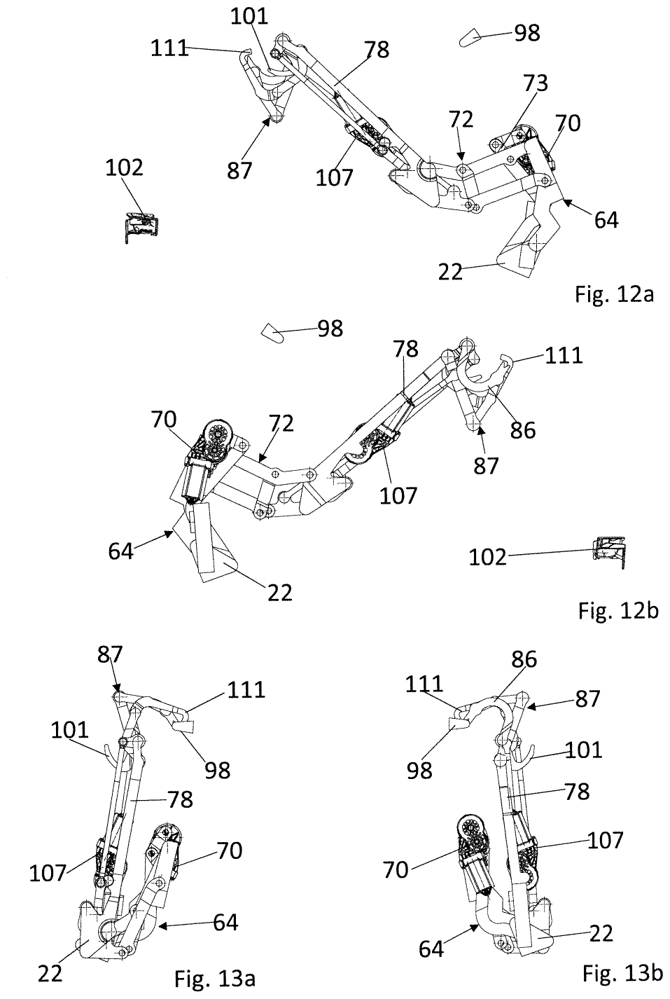

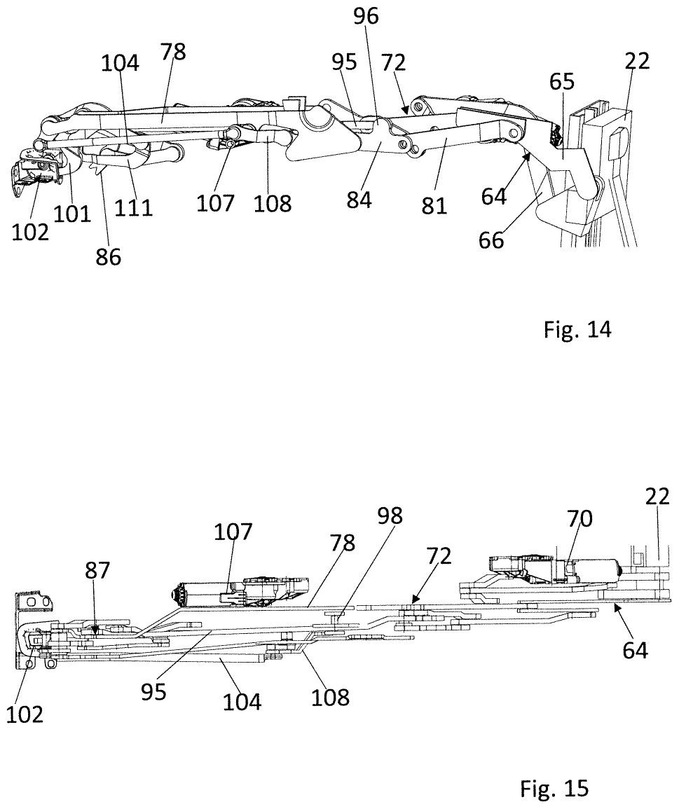

The drawing shows a convertible vehicle 10, which is provided with a displaceable convertible top 12, which is displaceable between a cover position (shown in FIG. 1), in which it spans a vehicle interior 14, and a storage position (shown in FIG. 5, for example), in which it is disposed in a convertible top storage area 16 disposed to the rear of vehicle interior 14. The convertible top 12 comprises a convertible top linkage 18, which comprises a link arrangement 20 on either side of a vertical longitudinal convertible-top center plane, said link arrangements 20 each being mounted so as to be pivotable on a respective main bearing 22. Each main bearing 22 is displaceable in the vertical vehicle direction on a respective guide rail 24A or 24B fixed to the body of the vehicle.

The convertible top 12 is designed as a so-called RHT (Retractable Hard Top) and, for forming a roof skin arrangement, comprises two rigid roof shells 26 and 28, which have outer sides which are disposed flush behind one another in the cover position when viewed in the longitudinal vehicle direction and are disposed in an upright position in the top storage area 16 in the storage position in such a manner that the front roof shell 26 is disposed in front of the rear-side roof shell 28 in the front vehicle direction. The edges of the roof shells 26 and 28 pointing in the direction of the vehicle front in the cover position therefore point towards the top. The rear roof shell 28 overlaps the outer side of the front roof shell 26 from behind (see FIG. 5). In the cover position, the front roof shell 26 is fixed to a front header 30 of the convertible vehicle 10 which forms an upper transverse leg of a frame of a windshield 32.

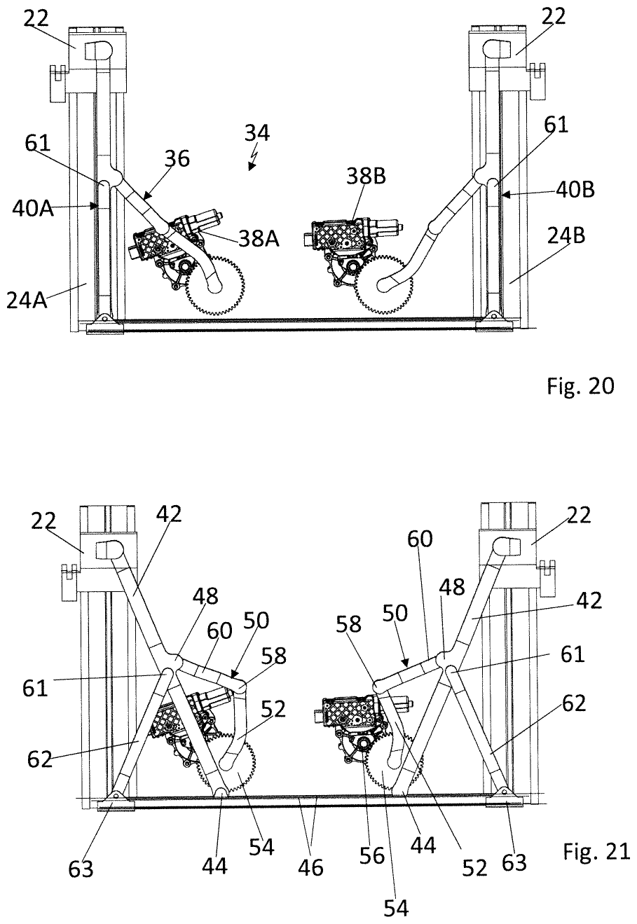

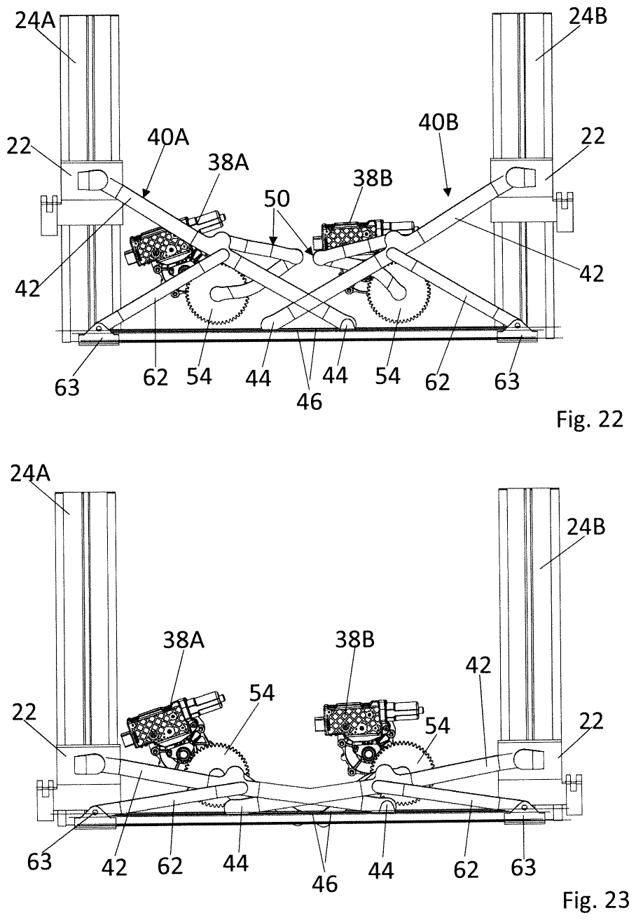

In order to be able to adjust the main bearing 22 on the guide rails 24A and 24B, the convertible top 12 has a drive arrangement 34 which is designed as a lifting mechanism and comprises a lever arrangement 36, which is articulated to the two main bearings 22 and is driven by two drive motors 38A and 38B (see FIGS. 20 to 23).

For each of the two main bearings 22, the lever arrangement 36 comprises a lever unit 40A or 40B, respectively, which can be driven by the respective drive motor 38A or 38B, respectively. The drive motors 38A and 38B are driven synchronously so that the lever units 40A and 40B can be adjusted synchronously. For example, synchronization can be achieved by meshing the gears of the two lever units 40A and 40B (not shown). It is also conceivable that the two lever units 40A and 40B are driven by a shared drive motor.

The two lever units 40A and 40B each comprise a plurality of links which are pivotable in the transverse vehicle direction and/or the transverse convertible-top direction. In particular, the lever units 40A and 40B each comprise a main link 42, whose one end is articulated to the respective main bearing 22 and whose other end is pivotably connected to a slider 44, which is displaceably guided in a respective guide track 46 disposed in a fixed manner on the body of the vehicle and extending in the transverse convertible-top direction. A drive link arrangement 50 is articulated to the main link 42 at a respective hinge point 48 and comprises a drive lever 52 which is non-rotatably connected to a toothed wheel 54 which is drivable by a drive pinion 56 of the respective drive motor 38A and/or 38B. At the end facing away from the respective toothed wheel 54, the drive levers 52 are each connected to a link 60 of the drive link arrangement 50 via a hinge point 58, the link 60 being articulated to the respective main link 42 at the hinge point 48.

At a further hinge point 61, a support link 62 is articulated to the main link 42 and in turn is articulated to a respective bearing block 63, which is fixed to the body of the vehicle and/or stationary relative to the guide rails 24A and 24B. In the lifted position of the main bearings 22 shown in FIG. 20, the drive link arrangements 50 each assume an over-dead-center position, so that the lifted position of the main bearing 22 is secured.

When the drive motors 38A and 38B, which are designed as electric motors, are actuated from the lifted position shown in FIG. 20, an adjusting torque is exerted on the main bearings 22 via the drive link arrangement 50 and the main link 42 so that these can be displaced on the guide rails 24A and 24B and transferred to a lowered position shown in FIG. 23.

Alternatively, it is also conceivable that the drive link arrangements 50 are each articulated to the respective support link 62. Furthermore, it is also conceivable that the drive link arrangements 50 comprise not only two, but also three or more links.

The link arrangements 20 of the convertible top linkage 18 disposed on either side of the vertical longitudinal convertible-top center plane are at least largely mirror-symmetrical to one another, for which reason reference is made below essentially only to the link arrangement 20 disposed on the left in relation to the forward direction of travel of the convertible vehicle 10. The link arrangement disposed on the right in relation to the forward direction of travel of the convertible vehicle 10 is designed in a similar manner.

Starting from the height-adjustable main bearing 22, the link arrangements 20 each comprise a four-bar linkage 64, which forms a first multi-bar linkage and which comprises two main links 65 and 66, which are pivotably mounted on the respective main bearing 22. In addition, the four-bar linkage 64 comprises a coupling link 67 which is in the form of a drive link and which is articulated to the main link 66 at a hinge point 68 and is connected to a drive pinion of a drive motor 70 at a pivot point 69, the drive motor 70 being in the form of an electric motor and being rigidly fastened to the main link 65 constituting a bearing link. The drive motor 70 is to be regarded as a component of the four-bar linkage. The rear roof shell 28 is fastened to the main link 65.

The four-bar linkage 64 is coupled to a seven-bar linkage 72, which represents a second multi-bar linkage, via a coupling link 73, which is connected to the four-bar linkage 64 at the hinge point 68 on the one hand and is connected to a base link 75 of the seven-bar linkage 72 at a hinge point 74 on the other hand. To form the seven-bar linkage 72, the base link 75 is articulated to the main link 65 of the four-bar linkage 64 at one end at a hinge point 76 and to a double-shell bearing link 78 at a second end at a hinge point 77, the bearing link 78 being disposed on the front side in the cover position of the convertible top 12 and the front roof shell 26 being mounted on the bearing link 78. The base link 75 is slightly angled and has a hinge point 79 at its bend point, a coupling link 59 being articulated at the hinge point 79 and being articulated to a further base link 81 of the seven-bar linkage 72 at a hinge point 80, the base link 81 being articulated to the main link 65 of the four-bar linkage 64 at a hinge point 82. At its end facing away from the main link 65, the base link 81 has a further hinge point 83, via which it is connected to an intermediate link 84, which is connected to the bearing link 78 at a hinge point 85. The two base links 75 and 81, the main link 65, the coupling link 59, the intermediate link 84 and the bearing link 78 thus form the seven-bar linkage 72 via the described hinge points 76, 77, 79, 80, 82, 83 and 85.

By means of the four-bar linkage 64 and the seven-bar linkage 72, it is possible to pivot the rear roof shell 28 to the upright position from the closed position shown in FIG. 1 by actuating the drive motor 70, and to move the front roof shell 26, which is mounted on the bearing links 78, to the upright position as well, in which it is disposed directly in front of the rear roof shell 28 (see FIGS. 4 and 5).

Furthermore, the two link arrangements 20 are each provided with a stop link 86, which is a component of a stop link arrangement 87. The stop link arrangement 87 forms a four-bar linkage with the bearing link 78 and comprises, in addition to the stop link 86, which is pivotably mounted on the bearing link 78 at a hinge point 88, a link 90 mounted on the bearing link 78 at a hinge point 89 and connected to a coupler 92 via a hinge point 91 at its end facing away from the hinge point 89, the coupler 92 being articulated to the stop link 86 at a hinge point 93. The stop link 86 has a fork-like stop surface 97 on the end face, the stop surface 97 representing the effective surface of the stop link 86.

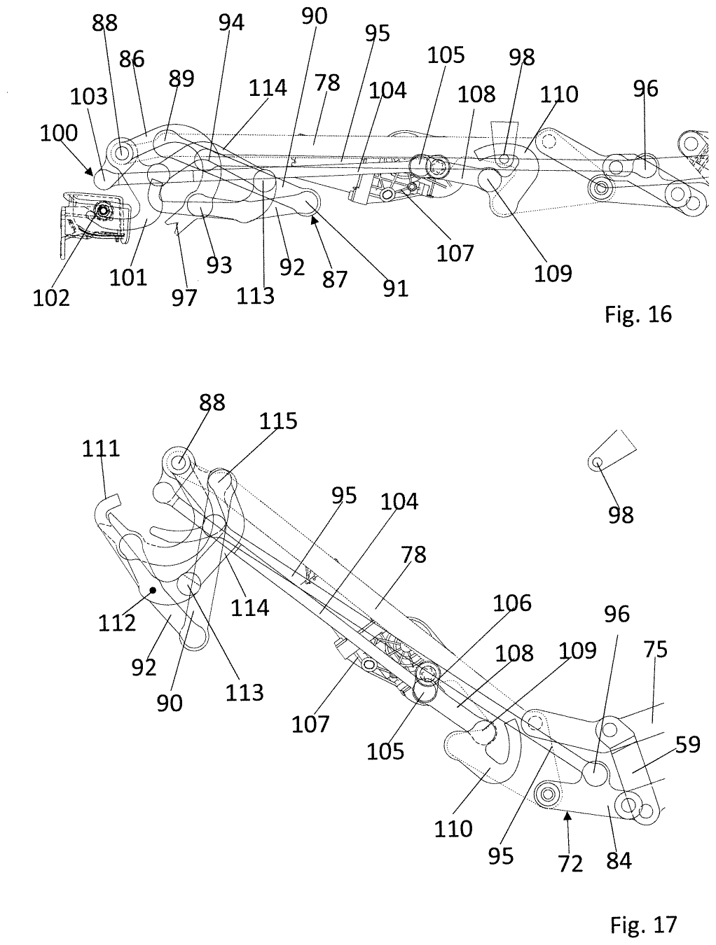

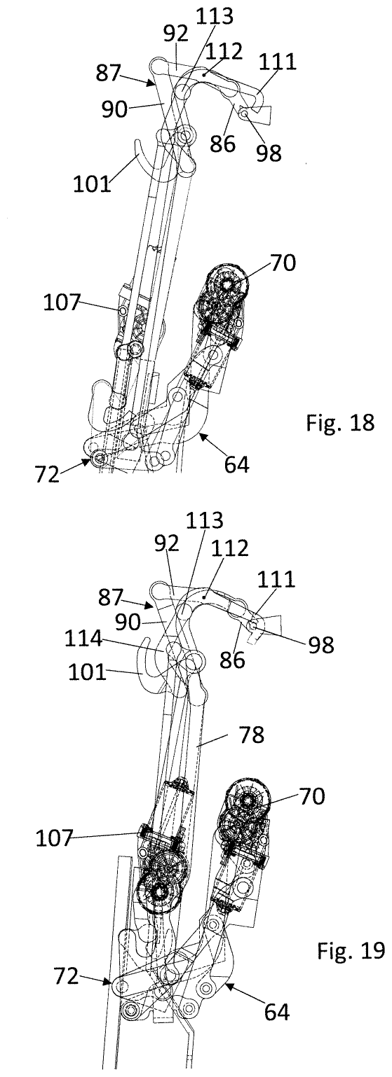

For actuation, the link 90 of the stop link arrangement 87 is connected to a drive rod 95 at a hinge point 94, the end of the drive rod 95 facing away from the stop link arrangement 87 being connected to the intermediate link 84 of the seven-bar linkage 72 at a hinge point 96. Via the drive rod 95, the stop link 86 can be pivoted from its rest position shown in FIG. 16 to the active position shown in FIGS. 18 and 19, where it engages over a front edge of the front roof shell 26 and the stop surface 97 rests against a counter stop element 98, which is disposed on the underside of the rear roof shell 28 and is designed in the manner of a roll. The relative position between the two roof shells 26 and 28 in the storage position of the convertible top 12 is defined by the stop links 86 which are disposed on both sides and rest against the counter stop elements 98 disposed on both sides via their stop surfaces 97.

To secure the convertible top 12 in the cover position, a closing unit 100 is provided at each of the link arrangements 20 disposed on either of two sides, the closing unit 100 comprising a front locking hook 101 whose pivot axis coincides with the pivot axis of the stop link 86, i.e., which can also be pivoted about the pivot axis defined by the hinge point 88 and, in its locking position shown in FIG. 16, is engaged with a locking element 102 disposed on the front header 30. For the drive, the locking hook 101 is connected to a lock rod 104 via a hinge point 103, an end of the lock rod facing away from the locking hook 101 being articulated to a drive lever 106 via a hinge point 105, the drive lever 106 being driven by a front closing drive 107 designed as an electric motor. A further closing rod 108 is articulated to the drive lever 106 via the hinge point 105 and is connected to a closing hook 110 via a hinge point 109, the closing hook 110, when in the cover position of the convertible top 12, being engaged with the counter stop element 98, which forms a flying stop and is disposed on the underside of the rear roof shell 28. This secures the two roof shells 26 and 28 to each other in the cover position.

In order to secure the two roof shells 26 and 28 to each other in the storage position, the link arrangements 20 disposed on either of two sides also have a stop lock 111, which is pivotably mounted on the coupling 92 of the stop link arrangement 87 at a hinge point 112 and is connected to a coupling link 114 via a hinge point 113, the coupling link 114 being articulated to the locking hook 101 at a hinge point 115. By actuating the front closing drive 107, it is therefore possible to pivot the stop lock 111 between a release position (see FIG. 18) and a locking position (see FIG. 19) via the lock rod 104, the locking hook 101 and the coupling link 114, where it engages with the counter stop element 98 and thus holds the front roof shell 26 on the rear roof shell 28. This provides an intermediate shell locking mechanism in which support is provided between the various elements within the kinematics. The support is provided on the side of the roof shell 28 on which the movement is initiated when the drive motor 70 is actuated. In the storage position, the two roof shells 26 and 28 are equally curved behind each other. When the roof shells 26 and 28 are moved to the cover position, the stop links 86 are pivoted from the active position to the rest position located below the roof shell 26. In the active position, however, the stop links 86 provide stable support between the roof shells 26 and 28. The stop locks 111, which are designed like hooks, allow the roof shells 26 and 28 to be actively locked together in the storage position. The locking mechanism not only prevents the attached roof shell 28 from moving against the displaceable stop link 86, but also prevents the roof shell 28 from moving in the opposite direction. This completely fixes the relative movement of the roof shells 26 and 28 to each other.

### REFERENCE SIGNS

10 convertible vehicle
12 convertible top
14 vehicle interior
16 convertible top storage area
18 convertible top linkage
20 link arrangement
22 main bearing
24A, B guide rail
26 roof shell
28 roof shell
30 front header
32 windshield
34 drive arrangement
36 lever arrangement
38A, B drive motor
40A, B lever unit
42 main link
44 slider
46 guide track
48 hinge point
50 drive link arrangement
52 drive lever
54 toothed wheel
56 drive pinion
58 hinge point
59 coupling link
60 link
61 hinge point
62 support link
63 bearing block
64 four-bar linkage
65 main link
66 main link
67 coupling link
68 hinge point
69 pivot point
70 drive motor
72 seven-bar linkage
73 coupling link
74 hinge point
75 base link
76 hinge point
77 hinge point
78 bearing link
79 hinge point
80 hinge point
81 base link
82 hinge point
83 hinge point
84 intermediate link
85 hinge point
86 stop link
87 stop link arrangement
88 hinge point
89 hinge point
90 link
91 hinge point
92 coupler
93 hinge point
94 hinge point
95 drive rod
96 hinge point
97 stop surface
98 counter stop element
100 closing unit
101 locking hook
102 locking element
103 hinge point
104 lock rod
105 hinge point
106 drive lever
107 front closing drive
108 closing rod
109 hinge point
110 closing hook
111 stop lock
112 hinge point
113 hinge point
114 coupling link
115 hinge point

1. A convertible top comprising:
a roof skin arrangement and a convertible top linkage by which the roof skin arrangement is displaceable between a cover position spanning the vehicle interior and a storage position releasing the vehicle interior towards the top and
which comprises a link arrangement on either side of a vertical longitudinal convertible-top center plane, said link arrangements each being mounted so as to be pivotable on a respective main bearing, which is displaceable on a guide rail by means of a drive arrangement,
the drive arrangement comprising a lever arrangement which is hinged to the main bearings and which is driven by at least one drive motor.

2. The convertible top according to claim 1, wherein the lever arrangement comprises a plurality of links which are pivotable in the transverse convertible-top direction.

3. The convertible top according to claim 1, wherein the lever arrangement comprises two main links which are each hinged to one of the main bearings and whose respective end facing away from the respective main bearing is guided on a guide track extending in the transverse convertible-top direction.

4. The convertible top according to claim 3, wherein each main link is connected to a drive link arrangement which is driven by the drive motor.

5. The convertible top according to claim 3, wherein each main link is connected to one support link, which supports itself on a vehicle-mounted bearing with its end facing away from the respective main link.

6. The convertible top according to claim 3, wherein the drive motor is mounted on a connecting element between the guide tracks extending in the transverse convertible-top direction.

7. The convertible top according to claim 1, wherein the drive motor is an electric motor.
